(19) United States
(12) Patent Application Publication
(10) Pub. No.: US 2008/0052228 A1
(43) Pub. Date: Feb. 28, 2008

(54) Methods and systems for providing partially redeemable offering notes

(75) Inventors: Morgan Baumann, New York, NY (US); Ashees Jain, New York, NY (US); Oren Bassik, New York, NY (US); Adnan Choudhury, London (GB); Sergey Pichugov, New York, NY (US)

Correspondence Address: MORGAN LEWIS & BOCKIUS LLP, 1111 PENNSYLVANIA AVENUE NW, WASHINGTON, DC, 20004, US

(73) Assignee: Lehman Brothers Inc., New York, NY (US)

(21) Appl. No.: 11/784,088

(22) Filed: Apr. 4, 2007

Related U.S. Application Data
(60) Provisional application No. 60/789,544, filed on Apr. 4, 2006.

(51) Int. Cl. G06Q 40/00

(52) U.S. Cl. 705/39

(57) ABSTRACT

In one aspect, the invention comprises a method comprising: (a) creating a partially redeemable offering note; (b) pricing the note; (c) issuing the note; and (d) redeeming the note. In another aspect, the invention comprises a method comprising: (a) buying a partially redeemable offering note issued by an issuer; and (b) receiving a first payment from the issuer for a first fraction between 0 and 1 of a notional amount of the note. In another aspect, the invention comprises a note with terms comprising: (a) a notional amount; (b) a schedule of two or more redemption dates; and (c) options for redeeming a percentage of the notional amount on at least two of the two or more redemption dates.

### CROSS REFERENCE TO RELATED APPLICATIONS

This application claims priority to U.S. Provisional Patent Application No. 60/789,544, filed Apr. 4, 2006. The entire contents of that provisional application are incorporated herein by reference.

### BACKGROUND AND SUMMARY

A callable bond is a bond that can be called (redeemed) by the issuer prior to its maturity, on certain call dates, at the call price. In other words, on the call dates, the issuer has the right, but not the obligation, to buy back the bonds from the bond holders at the call price. Thus, the issuer has an option, for which he pays in the form of a higher coupon rate. If interest rates in the market have gone down at the time of the call date, the issuer will be able to refinance his debt at a cheaper level, and thus will call the bonds.

The largest market for callable bonds is that of issues from government-sponsored entities such as Fannie Mae and Freddie Mac, whose assets comprise mortgages and mortgage-backed securities. U.S. mortgages are have historically been primarily fixed rate and without pre-payment penalties. If rates go down, many property owners will refinance at a lower rate, causing the agencies to lose assets. The agencies hedge this risk by issuing a large number of callable bonds, which allows them to call their own issues and refinance at a lower rate.

With a callable bond, an investor receives a higher coupon than with a bullet (non-callable) bond. On the other hand, if interest rates go down, the bonds get called and the investor can only invest at the lower rate. This is comparable to selling an option—one gets a premium up front, but has downside if the option gets exercised.

A preferred embodiment of the present invention comprises a method of providing securities that pay a fixed/floating coupon on the outstanding notional. The securities have a partial redemption/call option of x % of the notional amount per year. Thus, these notes provide advantages of both a bullet bond and a regular callable bond. The investor gains yield vs. a bullet but gives yield as compared to a callable.

One difference between the notes of embodiments of the invention (referred to herein for convenience as “partially redeemable offering notes,” or “PROs”) and other redeemable securities is that the former are only partially redeemed, and thus have performance characteristics of both bullet and callable notes.

Also, this structure and performance will mimic the performance of a mortgage bond. Therefore, these types of securities will provide a better hedge for mortgages and will provide a new alternative to a regular callable bond.

In one aspect, the invention comprises a method comprising: (a) creating a partially redeemable offering note; (b) pricing the note; (c) issuing the note; and (d) redeeming the note.

In various embodiments: (1) the partially redeemable offering note has an option for redeeming a fixed percentage of a notional amount of the note on a periodic basis; (2) the periodic basis is an annual basis; (3) the fixed percentage is less than 100%; (4) the partially redeemable offering note has an option for redeeming a variable percentage of a notional amount of the note on a periodic basis; (5) the periodic basis is an annual basis; (6) the variable percentage is less than 100%; (7) the pricing is based on Bermuda option pricing; (8) the pricing is based on a tree-based model using a backward-induction algorithm; (9) the redeeming is a first partial redeeming for a first fraction between 0 and 1 of a notional amount of the note at a first time; and (10) the redeeming is a second partial redeeming for a second fraction between 0 and 1 of a notional amount of the note at a second time, and wherein the second fraction is less than or equal to the difference between the first fraction and 1.

In another aspect, the invention comprises a method comprising: (a) buying a partially redeemable offering note issued by an issuer; and (b) receiving a first payment from the issuer for a first fraction between 0 and 1 of a notional amount of the note.

In various embodiments: (1) the partially redeemable offering note has an option for redeeming a fixed percentage of the notional amount of the note on a periodic basis; (2) the periodic basis is an annual basis; (3) the fixed percentage is less than 100%; (4) the partially redeemable offering note has an option for redeeming a variable percentage of the notional amount of the note on a periodic basis; (5) the periodic basis is an annual basis; (6) the variable percentage is less than 100%; (7) the note is priced based on Bermuda option pricing; (8) the note is priced based on a tree-based model using a backward-induction algorithm; and (9) the method further comprises receiving a second payment for a second fraction between 0 and 1 of the notional amount of the note, and wherein the second fraction is less than or equal to the difference between the first fraction and 1.

In another aspect, the invention comprises a note with terms comprising: (a) a notional amount; (b) a schedule of two or more redemption dates; and (c) options for redeeming a percentage of the notional amount on at least two of the two or more redemption dates.

In various embodiments: (1) the percentage is the same for two or more redemption dates; (2) the percentage varies for two or more redemption dates; (3) the redemption dates are spaced one year apart; (4) the note is priced based on Bermuda option pricing; and (5) the note is priced based on a tree-based model using a backward-induction algorithm.

### DETAILED DESCRIPTION OF EXEMPLARY EMBODIMENTS

In embodiments of the invention, notes are sold at 100% (or fractions thereof) of par. The notes are partially redeemable by the issuer at specified fraction (e.g., 10%) of notional at specified points in time (e.g., at one year intervals, on the anniversary of issuance). There is no obligation to redeem. However, any redemption must be on the specified dates and for the specified percentages.

For example, the issuer may forgo redemption until the last specified redemption date. However, since only 10% of notional is redeemable at any one time, the issuer is limited to calling only 10% of the notes on that date.

In some embodiments, the specified percentage is always the same for any redemption. In other embodiments, the percentage may vary. For example, it may increase (10% for the first redemption, 20% for the next) or decrease (e.g., 30% for the first redemption, 15% for the next), or may change based on other factors.

Pricing

In finance, a swap is a derivative where two counterparties exchange one stream of cash flows against another stream. The cash flows are calculated over a notional principal amount. One example of a swap is a fixed-to-floating interest rate swap. In this swap, A makes periodic interest payments to B based on a variable interest rate of, for example, LIBOR+50 basis points. Party B makes periodic interest payments based on, for example, a fixed rate of 3%. The payments are calculated over the notional amount. The first rate is called variable, because it is reset at the beginning of each interest calculation period to the then current reference rate, such as LIBOR.

An option on a swap is called a swaption. There are three basic styles of swaptions: (1) an American swaption, in which the owner is allowed to enter a swap on any day that falls within a range of two dates; (2) a Bermudan swaption, in which the owner is allowed to enter the swap on any one of a sequence of dates; and (3) a European swaption, in which the owner is allowed to enter the swap only on one specified date.

In a standard Bermudan swaption, the option holder has the right to exercise only once during the life of the option, on any one of certain contractually-set exercise dates. Such an option is typically priced on a tree-based model using a backward induction algorithm.

On each individual exercise date prior to the last, the option holder has the choice to either exercise the option to enter into the underlying swap, or to postpone the decision until a later contractual date. On the very last exercise date, the Bermudan simply becomes a European-style swaption. Thus, the Bermudan optionality in such a swap may be viewed as a portfolio of European-style swaptions—with the caveat that only one of those individual swaptions can be exercised.

The value of a Bermudan swaption can be thought of as (a) the value of the most expensive European-style swaption, plus (b) the value of the “switch option”—the ability to switch between different European-style swaptions.

In contrast to a Bermudan swaption, a PRO can be exercised more than once, and upon each exercise its notional amount is reduced by the amount exercised. For example, suppose that an owner of such a swaption can contractually exercise 20% of the initial notional on any exercise date. That option can be exercised up to 5 times. By analogy, the value of a PRO is the value of the most expensive combination of up to 5 European-style swaptions (each with notional equal to 20% of the notional of the entire structure) plus the value of the switch option. The exercise decision is more complex than that for a standard Bermudan swaption, since the option holder for the PRO structure has to determine a combination of five distinct exercise dates rather than just a single option exercise date, with the particular choice of the 5 swaptions determined by an intricate web of interrelated decisions.

The PRO product can be priced on a tree-based model using a backward-induction algorithm. In the particular example given above, at each step of backward induction the algorithm determines the optimal combinations of 1, 2, 3, 4, and 5 swaptions. The value of the PRO product is then the time-0 value—as determined by traversing the tree back to its root—of the value of the 5-swaptions combination.

For another example, consider a 10 yr note annually callable according the following call structure:

Yr 1: 10%

Yr 2: 15%

Yr 3: 20%

Yr 4: 25%

Yr 5: 30%

The number of paths to the option exercise decision date grows exponentially. The amount outstanding is:

Y1: 100 or 90

Y2: 100, 85 or 90, 75

Y3: 100, 80 or 85, 65, or 90, 70 or 75, 55

. . .

Y5: 32 potential notational sizes outstanding.

Consequently, the number of potential decisions to price in the backward induction methodology is much more complex as the number of potential decisions that are dependent on each other increases. This is most apparent when a constant call amount is not used for each period.

Clearly this pricing is much more complex than pricing a Bermudan option. This example further illustrates the factors to be considered when pricing PROs.

More generally, a pricing model of an embodiment pulls in various market data, such as Eurodollar futures, LIBOR, swaps, treasuries, and the volatility surface. It generates forward curves and uses our calibrations across the volatility surface to price all types of callable bonds/swaps. The model generates a tree across various interest rate paths to solve for the value of the options. These steps are standard in pricing either European or Bermudan options, and as such are known to those skilled in the art.

However, in a pricing model of an embodiment, the exercise decision is dependent on all future decisions. From a modeling perspective, this requires accounting for each potential decision at each call date and backwardly deducing a much more intricate set of decisions. As explained above, each of those decisions is almost always based on other decisions, and this dependence greatly increases the complexity of the model required.

The Appendix below provides an exemplary term sheet for an embodiment of the present invention.

It will be appreciated that the present invention has been described by way of example only, and that improvements and modifications may be made to the invention without departing from the scope or spirit thereof.

### Appendix

15 Yr Nc 1 Yr Partially Redeemable Offering (PRO) Notes
Exemplary Indicative Terms & Conditions

| | |
|---|---|
| Issuer: | FHLB |
| CUSIP: | TBD |
| Underwriter(s): | Lehman Brothers |
| Principal Amount: | $100 mm |
| Issue Date: | Apr. 6, 2006 |
| Maturity Date: | Apr. 6, 2021 |
| Redemption Date(s): | 20% of original notional amount is Callable |
| | Apr. 6, 2007 and annually thereafter, at par, |
| | with 5 New York Business Days notification. |
| Interest Payment Dates: | Semi-annually on April 6th, and October 6th |
| | of each year, commencing Oct. 6th, 2006. |
| Interest Rate: | Year 1-15: 5.625% |

All values input into formulas for the Interest Rate and intermediate calculations expressed as a percentage is rounded to five decimal places and any Interest Rate expressed as a percentage is rounded to three decimal places.

| | |
|---|---|
| Price to public: | 100% of Par |
| Minimum Denomination: | $100,000 and integral multiples of $1,000 |
| Day Count Convention: | 30/360 |
| Payment Convention: | Following New York Business Day with no |
| period | adjustment for end dates. |
| Calculation Agent: | Lehman Brothers Special Financing |

### Example Call Schedules

### #1: Assuming Optional Redemption on Each of First Five Redemption Dates

| | Amount Outstanding | Amount Outstanding |
|---|---|---|
| Date | Prior to Call | after Call |
| Apr. 6, 2007 | $100,000,000.00 | $80,000,000.00 |
| Apr. 6, 2008 | $80,000,000.00 | $60,000,000.00 |
| Apr. 6, 2009 | $60,000,000.00 | $40,000,000.00 |
| Apr. 6, 2010 | $40,000,000.00 | $20,000,000.00 |
| Apr. 6, 2011 | $20,000,000.00 | $— |

### #2: Assuming Optional Redemption Every Three Years

| | Amount Outstanding | Amount Outstanding |
|---|---|---|
| Date | Prior to Call | after Call |
| Apr. 6, 2007 | $100,000,000.00 | $100,000,000.00 |
| Apr. 6, 2008 | $100,000,000.00 | $100,000,000.00 |
| Apr. 6, 2009 | $100,000,000.00 | $80,000,000.00 |
| Apr. 6, 2010 | $80,000,000.00 | $80,000,000.00 |
| Apr. 6, 2011 | $80,000,000.00 | $80,000,000.00 |
| Apr. 6, 2012 | $80,000,000.00 | $60,000,000.00 |
| Apr. 6, 2013 | $60,000,000.00 | $60,000,000.00 |
| Apr. 6, 2014 | $60,000,000.00 | $60,000,000.00 |
| Apr. 6, 2015 | $60,000,000.00 | $40,000,000.00 |
| Apr. 6, 2016 | $40,000,000.00 | $40,000,000.00 |
| Apr. 6, 2017 | $40,000,000.00 | $40,000,000.00 |
| Apr. 6, 2018 | $40,000,000.00 | $20,000,000.00 |
| Apr. 6, 2019 | $20,000,000.00 | $20,000,000.00 |
| Apr. 6, 2020 | $20,000,000.00 | $20,000,000.00 |
| Apr. 6, 2021 | $20,000,000.00 | $— |

We claim:

1. A method comprising:
creating a partially redeemable offering note;
pricing said note;
issuing said note; and
redeeming said note.

2. A method as in claim 1, wherein said partially redeemable offering note has an option for redeeming a fixed percentage of a notional amount of said note on a periodic basis.

3. A method as in claim 2, wherein said periodic basis is an annual basis.

4. A method as in claim 2, wherein said fixed percentage is less than 100%.

5. A method as in claim 1, wherein said partially redeemable offering note has an option for redeeming a variable percentage of a notional amount of said note on a periodic basis.

6. A method as in claim 5, wherein said periodic basis is an annual basis.

7. A method as in claim 5, wherein said variable percentage is less than 100%.

8. A method as in claim 1, wherein said pricing is based on Bermuda option pricing.

9. A method as in claim 1, wherein said pricing is based on a tree-based model using a backward-induction algorithm.

10. A method as in claim 1, wherein said redeeming is a first partial redeeming for a first fraction between 0 and 1 of a notional amount of said note at a first time.

11. A method as in claim 1, wherein said redeeming is a second partial redeeming for a second fraction between 0 and 1 of a notional amount of said note at a second time, and wherein said second fraction is less than or equal to the difference between said first fraction and 1.

12. A method comprising:
buying a partially redeemable offering note issued by an issuer; and
receiving a first payment from said issuer for a first fraction between 0 and 1 of a notional amount of said note.

13. A method as in claim 12, wherein said partially redeemable offering note has an option for redeeming a fixed percentage of said notional amount of said note on a periodic basis.

14. A method as in claim 13, wherein said periodic basis is an annual basis.

15. A method as in claim 13, wherein said fixed percentage is less than 100%.

16. A method as in claim 12, wherein said partially redeemable offering note has an option for redeeming a variable percentage of said notional amount of said note on a periodic basis.

17. A method as in claim 16, wherein said periodic basis is an annual basis.

18. A method as in claim 16, wherein said variable percentage is less than 100%.

19. A method as in claim 12, wherein said note is priced based on Bermuda option pricing.

20. A method as in claim 12, wherein said note is priced based on a tree-based model using a backward-induction algorithm.

21. A method as in claim 12, further comprising receiving a second payment for a second fraction between 0 and 1 of said notional amount of said note, and wherein said second fraction is less than or equal to the difference between said first fraction and 1.

22. A note with terms comprising:
a notional amount;
a schedule of two or more redemption dates; and
options for redeeming a percentage of said notional amount on at least two of said two or more redemption dates.

23. A note as in claim 22, wherein said percentage is the same for two or more redemption dates.

24. A note as in claim 22, wherein said percentage varies for two or more redemption dates.

25. A note as in claim 22, wherein said redemption dates are spaced one year apart.

26. A note as in claim 22, wherein said note is priced based on Bermuda option pricing.

27. A note as in claim 22, wherein said note is priced based on a tree-based model using a backward-induction algorithm.
